(19) United States
(12) Patent Application Publication
(10) Pub. No.: US 2025/0386329 A1
(43) Pub. Date: Dec. 18, 2025

(54) TIME DOMAIN PATTERN FOR SS/PBSCH BLOCK RECEPTION

(71) Applicant: Samsung Electronics Co., Ltd., Suwon-si (KR)

(72) Inventors: Hongbo Si, Allen, TX (US); Jiayu Mao, Columbus, OH (US)

(21) Appl. No.: 19/215,211

(22) Filed: May 21, 2025

Related U.S. Application Data
(60) Provisional application No. 63/659,932, filed on Jun. 14, 2024.
(60) Provisional application No. 63/668,064, filed on Jul. 5, 2024.
(60) Provisional application No. 63/730,643, filed on Dec. 11, 2024.

(51) Int. Cl. H04W 72/0446; H04B 7/06; H04W 76/40

(52) U.S. Cl. CPC H04W 72/0446; H04B 7/06968; H04W 76/40

(57) ABSTRACT

Apparatuses and methods for a synchronization signals and physical broadcast channel (SS/PBCH) block burst pattern in a wireless communication system. A method of a user equipment (UE) in a wireless communication system includes identifying a time domain pattern for SS/PBCH block bursts. The time domain pattern indicates a periodicity for the SS/PBCH block bursts, a first number (N) of SS/PBCH block bursts in the periodicity, and a second number (M) of SS/PBCH blocks in a SS/PBCH block burst within the SS/PBCH block bursts. The method further includes determining time domain candidate occasions for the SS/PBCH blocks, based on the time domain pattern and receiving a SS/PBCH block from the SS/PBCH blocks in the time domain candidate occasions.

### CROSS-REFERENCE TO RELATED APPLICATIONS AND CLAIM OF PRIORITY

The present application claims priority to:
U.S. Provisional Patent Application No. 63/659,932, filed on Jun. 14, 2024;
U.S. Provisional Patent Application No. 63/668,064, filed on Jul. 5, 2024; and
U.S. Provisional Patent Application No. 63/730,643, filed on Dec. 11, 2024.

The contents of the above-identified patent documents are incorporated herein by reference.

### TECHNICAL FIELD

The present disclosure relates generally to wireless communication systems and, more specifically, the present disclosure relates to a synchronization signals and physical broadcast channel (SS/PBCH) block burst pattern in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a SS/PBCH block burst pattern in a wireless communication system.

In one embodiment, a user equipment (UE) in a wireless communication system is provided. The UE includes a processor configured to identify a time domain pattern for synchronization signals and physical broadcast channel (SS/PBCH) block bursts and determine time domain candidate occasions for the SS/PBCH blocks based on the time domain pattern. The time domain pattern indicates a periodicity for the SS/PBCH block bursts, a first number of SS/PBCH block bursts in the periodicity, and a second number of SS/PBCH blocks in a SS/PBCH block burst within the SS/PBCH block bursts. The UE further includes a transceiver operably coupled to the processor. The transceiver is configured to receive a SS/PBCH block from the SS/PBCH blocks in the time domain candidate occasions.

In another embodiment, a base station (BS) in a wireless communication system is provided. The BS includes a processor configured to determine a time domain pattern for SS/PBCH block bursts and determine time domain candidate occasions for the SS/PBCH blocks based on the time domain pattern. The time domain pattern indicates a periodicity for the SS/PBCH block bursts, a first number (N) of SS/PBCH block bursts in the periodicity, and a second number (M) of SS/PBCH blocks in a SS/PBCH block burst within the SS/PBCH block bursts. The BS further includes a transceiver operably coupled to the processor. The transceiver is configured to transmit the SS/PBCH blocks in the time domain candidate occasions.

In yet another embodiment, a method of a UE in a wireless communication system is provided. The method includes identifying a time domain pattern for SS/PBCH block bursts. The time domain pattern indicates a periodicity for the SS/PBCH block bursts, a first number (N) of SS/PBCH block bursts in the periodicity, and a second number (M) of SS/PBCH blocks in a SS/PBCH block burst within the SS/PBCH block bursts. The method further includes determining time domain candidate occasions for the SS/PBCH blocks, based on the time domain pattern and receiving a SS/PBCH block from the SS/PBCH blocks in the time domain candidate occasions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates an example of SS/PBCH block composition according to embodiments of the present disclosure;

FIG. 7 illustrates an example of SS/PBCH block time domain pattern in slots according to embodiments of the present disclosure;

FIG. 8 illustrates an example of slots comprising candidate SS/PBCH blocks in a half frame according to embodiments of the present disclosure;

FIG. 9 illustrates an example of first SS/PBCH block burst pattern in a periodic manner according to embodiments of the present disclosure;

FIG. 10 illustrates an example of first SS/PBCH block burst pattern in an aperiodic manner according to embodiments of the present disclosure;

FIG. 11 illustrates another example of second SS/PBCH block burst pattern in a periodic manner according to embodiments of the present disclosure;

FIG. 12 illustrates another example of second SS/PBCH block burst pattern in an aperiodic manner according to embodiments of the present disclosure;

FIG. 13 illustrates yet another example of second SS/PBCH block burst pattern in a periodic manner according to embodiments of the present disclosure;

FIG. 14 illustrates yet another example of second SS/PBCH block burst pattern in an aperiodic manner according to embodiments of the present disclosure;

FIG. 15 illustrates a flowchart of UE method for determining and using the SS/PBCH block burst pattern according to embodiments of the present disclosure;

FIG. 16 illustrates an example of non-periodic SSB transmission pattern according to

embodiments of the present disclosure;

FIG. 17 illustrates another example of non-periodic SSB transmission pattern according to embodiments of the present disclosure;

FIG. 18 illustrates yet another example of non-periodic SSB transmission pattern according to embodiments of the present disclosure;

FIG. 19 illustrates yet another example of non-periodic SSB transmission pattern according to embodiments of the present disclosure;

FIG. 20 illustrates an example of indication of non-periodic SSB transmission according to embodiments of the present disclosure; and

FIG. 21 illustrates a flowchart of UE method for an indication of non-periodic SSB transmission according to embodiments of the present disclosure.

### DETAILED DESCRIPTION

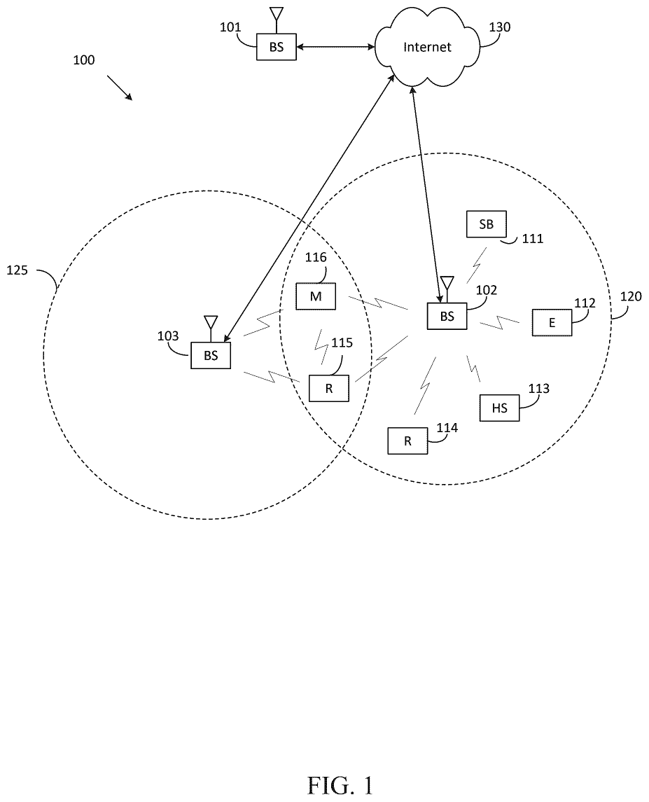

FIGS. 1-21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v18.0.0, “NR; Physical channels and modulation”; 3GPP TS 38.212 v18.0.0, “NR; Multiplexing and channel coding”; 3GPP TS 38.213 v18.0.0, “NR; Physical layer procedures for control”; 3GPP TS 38.214 v18.0.0, “NR; Physical layer procedures for data”; and 3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices.

Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered as a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a SS/PBCH block burst pattern in a wireless communication system. In certain embodiments, and one or more of the gNBs 101-103 includes circuitry, programing, or a combination thereof, for supporting an operation for configurations for a SS/PBCH block burst pattern in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

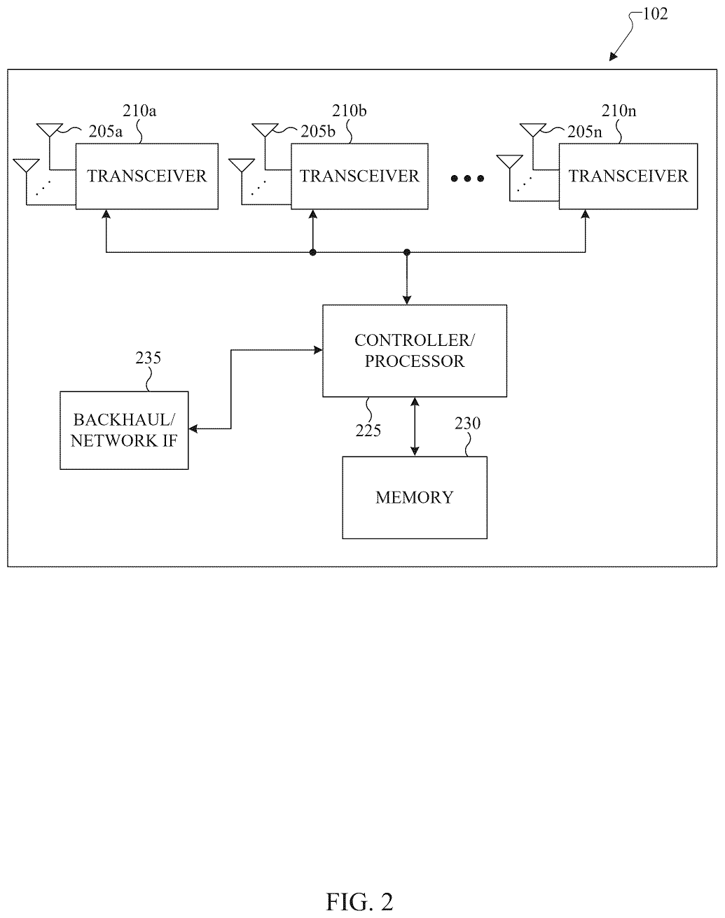

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a SS/PBCH block burst pattern in a wireless communication system. The controller/processor 225 can move data into or out of the memory 230 as performed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

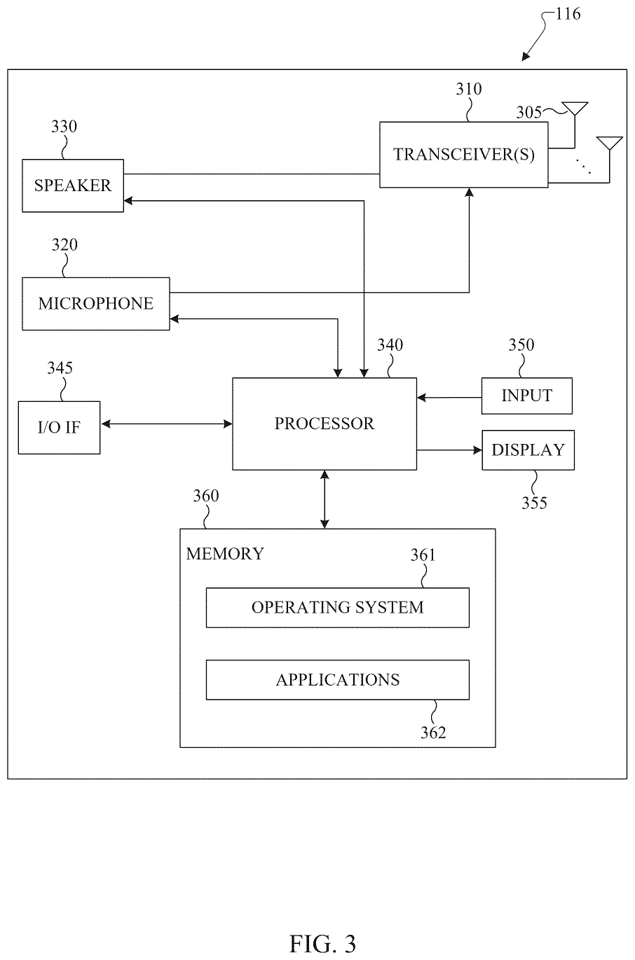

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a SS/PBCH block burst pattern in a wireless communication system.

The processor 340 can move data into or out of the memory 360 as performed by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

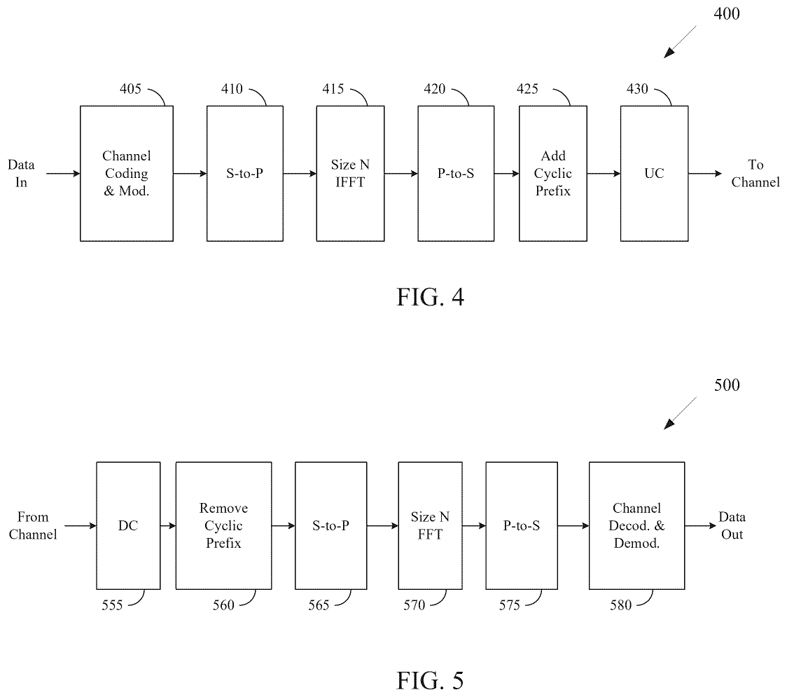

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the transmit path 400 is configured to utilize a SS/PBCH block burst pattern in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

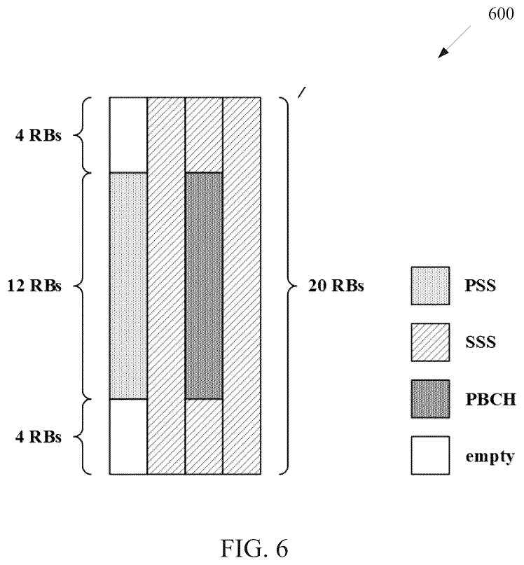

In NR Rel-15, each synchronization signals and physical broadcast channel (SS/PBCH) block compromises of four consecutive orthogonal frequency division multiplexing (OFDM) symbols, wherein the center 12 RBs of the first symbol are mapped for primary synchronization signal (PSS), the second and forth symbols ae mapped for PBCH, and the third symbol is mapped for both secondary synchronization signal (SSS) and PBCH. An illustration of the SS/PBCH block composition is shown in FIG. 6.

FIG. 6 illustrates an example of SS/PBCH block composition 600 according to embodiments of the present disclosure. An embodiment of the SS/PBCH block composition 600 shown in FIG. 6 is for illustration only.

The same SS/PBCH composition is applied to all supported carrier frequency ranges in NR, which spans from 0.41 GHz to 7.125 GHz as frequency range 1 (FR1), and spans from 24.25 to 52.6 GHz as frequency range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

NR Rel-15 supports one or two SCS for SS/PBCH block, for a given band, wherein the same SCS is applied to PSS, SSS, and PBCH (including its DM-RS). For FR1, 15 kHz and/or 30 kHz can be applied to SS/PBCH block, and for FR2, 120 kHz and/or 240 kHz can be applied to SS/PBCH block.

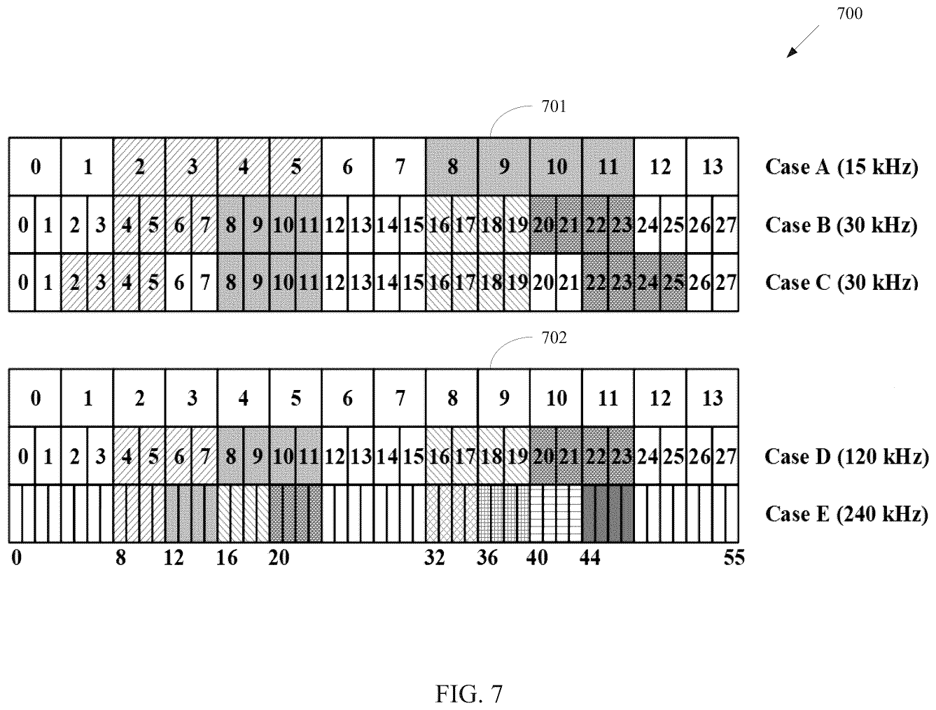

NR Rel-15 also supports multiple candidate SS/PBCH blocks within a time unit of half frame, wherein the time unit repeats in time domain with a configurable periodicity. The time domain pattern of SS/PBCH blocks to at least one slot is illustrated in FIG. 7. For FR1 (701), the SS/PBCH block pattern is designed according to 15 kHz as the reference SCS, and for FR2 (702), the SS/PBCH block pattern is designed according to 60 kHz as the reference SCS.

FIG. 7 illustrates an example of SS/PBCH block time domain pattern in slots 700 according to embodiments of the present disclosure. An embodiment of the SS/PBCH block time domain pattern in slots 700 shown in FIG. 7 is for illustration only.

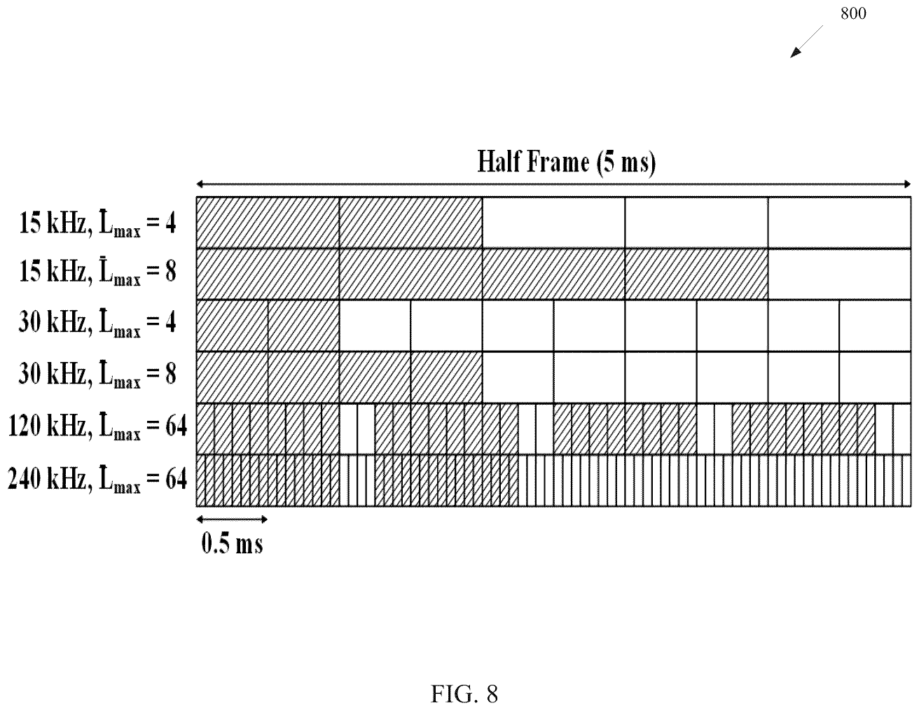

The maximum number of candidate SS/PBCH blocks, denoted as L̅ₘₐₓ, is determined based on carrier frequency range, and for FR1 and FR2 licensed spectrums, the value can be one of 4 or 8 or 64, for a given carrier frequency range. An illustration of the time domain pattern for the slots containing candidate SS/PBCH blocks within a half frame is shown in FIG. 8.

FIG. 8 illustrates an example of slots comprising candidate SS/PBCH blocks in a half frame 800 according to embodiments of the present disclosure. An embodiment of the slots comprising candidate SS/PBCH blocks in a half frame 800 shown in FIG. 8 is for illustration only.

For new generation of wireless communication, to save the energy of a base station, the periodicity for a periodic transmission of SS/PBCH blocks can be enlarged, and the time domain pattern for SS/PBCH block bursts can be enhanced accordingly.

The present disclosure provides the SS/PBCH block burst pattern in time domain. More precisely, the following aspects are included in the present disclosure: (i) SS/PBCH block burst pattern 1, wherein SS/PBCH block(s) can be transmitted in a periodic manner, and within each periodicity, N SS/PBCH block bursts can be transmitted, wherein each SS/PBCH block burst is confined within a time duration; (ii) SS/PBCH block burst pattern 2, wherein SS/PBCH block(s) can be transmitted in a periodic manner, and within each periodicity, N SS/PBCH block bursts can be transmitted and confined within a time duration, with a potential time domain gap between SS/PBCH block bursts; (iii) SS/PBCH block burst pattern 3, wherein SS/PBCH block(s) can be transmitted in a periodic manner, and within each periodicity, one SS/PBCH block burst can be transmitted and confined within a time duration; and (iv) example UE procedures.

In one embodiment, a first SS/PBCH block burst pattern can be supported.

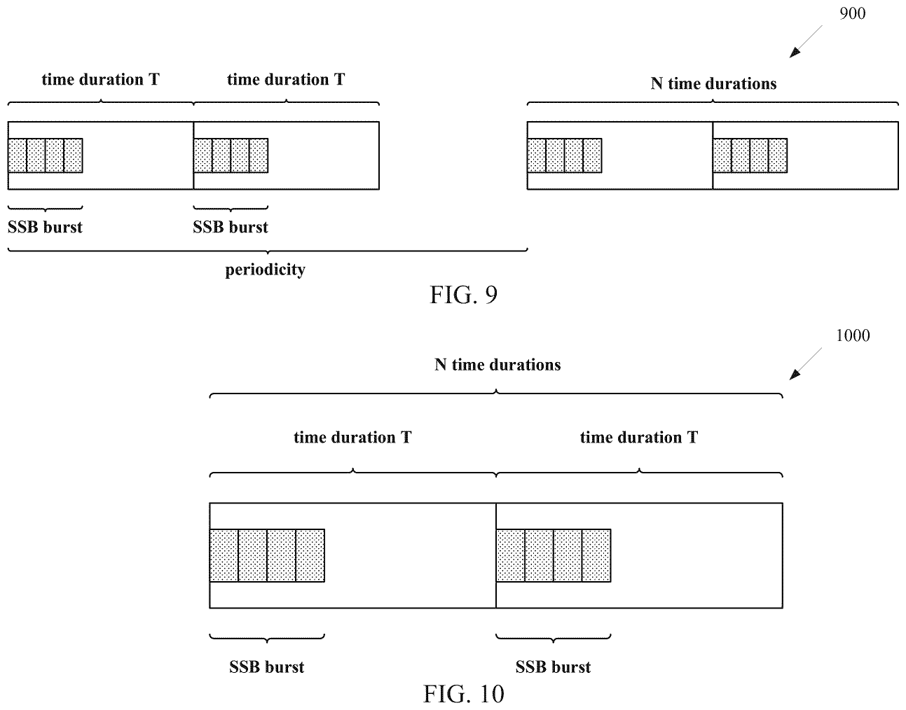

FIG. 9 illustrates an example of first SS/PBCH block burst pattern in a periodic manner 900 according to embodiments of the present disclosure. An embodiment of the first SS/PBCH block burst pattern in a periodic manner 900 shown in FIG. 9 is for illustration only.

For one example, as illustrated in FIG. 9, SS/PBCH block(s) can be transmitted in a periodic manner, and within each periodicity, N SS/PBCH block bursts can be transmitted, wherein each SS/PBCH block burst is confined within a time duration.

For another example, as illustrated in FIG. 10, SS/PBCH block(s) can be transmitted in an aperiodic manner, and N SS/PBCH block bursts can be transmitted, wherein each SS/PBCH block burst is confined within a time duration.

FIG. 10 illustrates an example of first SS/PBCH block burst pattern in an aperiodic manner 1000 according to embodiments of the present disclosure. An embodiment of the first SS/PBCH block burst pattern in an aperiodic manner 1000 shown in FIG. 10 is for illustration only.

The following notations may be used for the present disclosure: (i) P: a periodicity of the SS/PBCH block transmission, e.g., applicable when the transmission of SS/PBCH block burst is periodic; (ii) T: a time duration including a SS/PBCH block burst; (iii) D: a transmission duration of a SS/PBCH block burst. For example, it refers to the duration of slots including the SS/PBCH block burst, and the duration includes gaps between/before/after SS/PBCH blocks in the burst: (iv) N: a number of SS/PBCH block bursts in the periodicity (e.g., SS/PBCH block bursts can be indexed from 0 to N-1). For example, this is same as a number of time durations including SS/PBCH block bursts in the periodicity; and (v) M: a number (or a maximum number) of SS/PBCH blocks in a SS/PBCH block burst (e.g., SS/PBCH blocks in the SS/PBCH block burst can be indexed from 0 to M-1).

In one example, P can be configurable and provided by a higher layer parameter, e.g., after initial cell search procedure.

In another example, P can be predefined when it is not configured, e.g., in an initial cell search procedure.

For one example, P can be predefined based on a subcarrier spacing (SCS) of the SS/PBCH block.

For another example, P can be predefined based on a frequency range wherein the SS/PBCH block is transmitted.

For yet another example, P can be predefined based on a band number.

For yet another example, P can be predefined based on a global synchronization channel number (GSCN) value associated with the SS/PBCH block transmission (e.g., a center frequency of the SS/PBCH block is aligned with the GSCN).

For yet another example, P can be predefined as 40 ms. For yet another example, P can be predefined as 80 ms. For yet another example, P can be predefined as 160 ms.

In one example, the time duration T can be predefined, e.g., for initial cell search procedure. For one example, T can be predefined as a half frame (e.g., 5 ms). For another example, T can be predefined as a time unit to include all candidate occasions for SS/PBCH blocks in a SS/PBCH block burst. In another example, the time duration T can be configured, e.g., provided by a higher layer parameter, with such as a system information block and/or a dedicated RRC signalling. In yet another example, the time duration T can be configured as same as the transmission duration of a SS/PBCH block burst (e.g., D).

In one example, the transmission duration of a SS/PBCH block burst (e.g., D) can be predetermined based on the number (or the maximum number) of SS/PBCH blocks in a SS/PBCH block burst (e.g., M). For example, D=M/2 when D is a unit of slot.

In one example, the number of SS/PBCH block bursts in the periodicity (e.g., N) can be configured, e.g., provided by a higher layer parameter, with such as a system information block and/or a dedicated RRC signalling, e.g., after initial cell search procedure.

In another example, the number of SS/PBCH block bursts in the periodicity (e.g., N) can be predefined, e.g., in initial cell search procedure. For one example, N can be predefined based on a SCS of the SS/PBCH block. For another example, N can be predefined based on a frequency range wherein the SS/PBCH block is transmitted. For yet another example, N can be predefined based on a band number. For yet another example, N can be predefined based on a GSCN value associated with the SS/PBCH block transmission. For yet another example, N can be predefined as 1. For yet another example, N can be predefined as 2. For yet another example, N can be predefined as 3. For yet another example, N can be predefined as 4.

In yet another example, the number of SS/PBCH block bursts in the periodicity (e.g., N) can be determined based on the periodicity P. For one example, N=2 when P is larger than 20 ms. For another example, N=P/20.

In one example, M can be configurable and provided by a higher layer parameter, or determined based on a higher layer parameter, e.g., after initial cell search procedure.

In another example, M can be predefined, e.g., in initial cell search procedure. For one example, M can be predefined based on a SCS of the SS/PBCH block. For another example, M can be predefined based on a frequency range wherein the SS/PBCH block is transmitted. For yet another example, M can be predefined based on a band number. For yet another example, M can be predefined based on a GSCN value associated with the SS/PBCH block transmission.

For one embodiment, a quasi co location (QCL) assumption can be supported for the SS/PBCH blocks transmitted using the first SS/PBCH block burst pattern.

For one example, a UE can assume SS/PBCH blocks with a same SS/PBCH block index (e.g., index within a burst) (or a same candidate SS/PBCH block index within a burst) are QCLed, wherein the SS/PBCH blocks can be located according to at least one of the following cases: (i) in different time durations within a same periodicity, if the transmission is in a periodic manner; (ii) in different time durations of the transmission, if the transmission is in an aperiodic manner; (iii) in different periodicities, if the transmission is in a periodic manner.

For another embodiment, sequences mapped for PSS in different time durations within the same periodicity, if the transmission is in a periodic manner, or in different time durations of the transmission, if the transmission is in an aperiodic manner, can be different.

For one example, a first sequence is mapped for PSS in a first time duration and a second sequence is mapped for PSS in a second time duration, wherein the first sequence and the second sequence are generated using the same cyclic shift and different generation functions and/or different initial conditions.

For another example, a first sequence is mapped for PSS in a first time duration and a second sequence is mapped for PSS in a second time duration, wherein the first sequence and the second sequence are generated using the same generation function and initial condition, and different cyclic shifts.

For yet another embodiment, sequences mapped for SSS in different time durations within the same periodicity, if the transmission is in a periodic manner, or in different time durations of the transmission, if the transmission is in an aperiodic manner, can be different.

For one example, a first sequence is mapped for SSS in a first time duration and a second sequence is mapped for SSS in a second time duration, wherein the first sequence and the second sequence are generated using the same cyclic shift and different generation functions and/or different initial conditions.

For another example, a first sequence is mapped for SSS in a first time duration and a second sequence is mapped for SSS in a second time duration, wherein the first sequence and the second sequence are generated using the same generation function and initial condition, and different cyclic shifts.

In one embodiment, a second SS/PBCH block burst pattern can be supported.

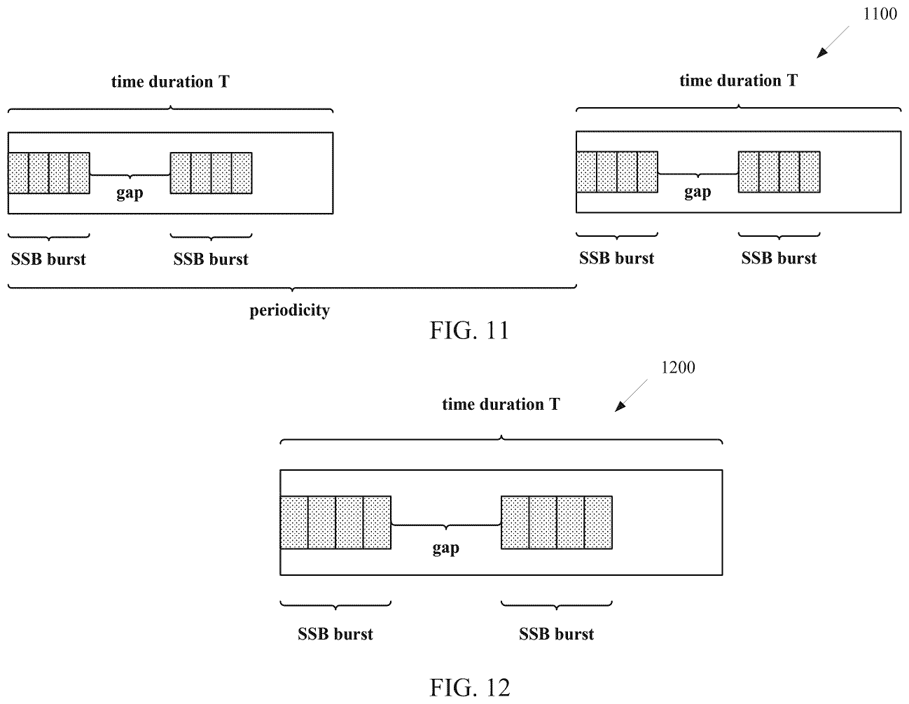

FIG. 11 illustrates another example of second SS/PBCH block burst pattern in a periodic manner 1100 according to embodiments of the present disclosure. An embodiment of the second SS/PBCH block burst pattern in a periodic manner 1100 shown in FIG. 11 is for illustration only.

For one example, as illustrated in FIG. 11, SS/PBCH block(s) can be transmitted in a periodic manner, and within each periodicity, N SS/PBCH block bursts can be transmitted and confined within a time duration, with a potential time domain gap between SS/PBCH block bursts.

FIG. 12 illustrates another example of second SS/PBCH block burst pattern in an aperiodic manner 1200 according to embodiments of the present disclosure. An embodiment of the second SS/PBCH block burst pattern in an aperiodic manner 1200 shown in FIG. 12 is for illustration only.

For another example, as illustrated in FIG. 12, SS/PBCH block(s) can be transmitted in an aperiodic manner, and N SS/PBCH block bursts can be transmitted and confined within a time duration, with a potential time domain gap between SS/PBCH block bursts.

The following notations may be used for the present disclosure: (i) P: a periodicity of the SS/PBCH block transmission, e.g., applicable when the transmission of SS/PBCH block burst is periodic; (ii) T: a time duration including all SS/PBCH block bursts in a periodicity; (iii) D: a transmission duration of a SS/PBCH block burst. For example, it refers to the duration of slots including the SS/PBCH block burst, and the duration includes gaps between/before/after SS/PBCH blocks in the burst; (iv) N: a number of SS/PBCH block bursts in the periodicity (e.g., SS/PBCH block bursts are indexed from 0 to N-1); (v) M: a number (or a maximum number) of SS/PBCH blocks in a SS/PBCH block burst (e.g., SS/PBCH blocks in the SS/PBCH block burst are indexed from 0 to M-1); and (vi) G: a time domain gap between SS/PBCH block bursts in the time duration.

In one example, P can be configurable and provided by a higher layer parameter, e.g., after initial cell search procedure.

In another example, P can be predefined when it is not configured, e.g., in an initial cell search procedure. For one example, P can be predefined based on a SCS of the SS/PBCH block. For another example, P can be predefined based on a frequency range wherein the SS/PBCH block is transmitted. For yet another example, P can be predefined based on a band number. For yet another example, P can be predefined based on a GSCN value associated with the SS/PBCH block transmission. For yet another example, P can be predefined as 40 ms. For yet another example, P can be predefined as 80 ms. For yet another example, P can be predefined as 160 ms.

In one example, the time duration T can be predefined. For one example, T can be predefined as a half frame (e.g., 5 ms). For another example, T can be predefined as 20 ms. For yet another example, T can be predefined as a time unit to include all candidate occasions for SS/PBCH blocks in all SS/PBCH block bursts within a periodicity.

In another example, the time duration T can be configured, e.g., provided by a higher layer parameter, such as a system information block and/or a dedicated RRC signalling, e.g., after initial cell search procedure.

In yet another example, the time duration T can be same as the transmission duration of all SS/PBCH block bursts.

In one example, the transmission duration of a SS/PBCH block burst (e.g., D) can be predetermined based on the number (or the maximum number) of SS/PBCH blocks in a SS/PBCH block burst (e.g., M). For example, D=M/2 when D is a unit of slot.

In one example, the number of SS/PBCH block bursts in the periodicity (e.g., N) can be configured, e.g., provided by a higher layer parameter, such as a system information block and/or a dedicated RRC signalling, e.g., after initial cell search procedure.

In another example, the number of SS/PBCH block bursts in the periodicity (e.g., N) can be predefined, e.g., in an initial cell search procedure. For one example, N can be predefined based on a SCS of the SS/PBCH block. For another example, N can be predefined based on a frequency range wherein the SS/PBCH block is transmitted. For yet another example, N can be predefined based on a band number. For yet another example, N can be predefined based on a GSCN value associated with the SS/PBCH block transmission. For yet another example, N can be predefined as 1. For yet another example, N can be predefined as 2. For yet another example, N can be predefined as 3. For yet another example, N can be predefined as 4.

In yet another example, the number of SS/PBCH block bursts in the periodicity (e.g., N) can be determined based on the periodicity P. For one example, N=2 when P is larger than 20 ms. For another example, N=P/20.

In one example, M can be configurable and provided by a higher layer parameter, or determined based on a higher layer parameter, e.g., after initial cell search procedure.

In another example, M can be predefined, e.g., in an initial cell search procedure. For one example, M can be predefined based on a SCS of the SS/PBCH block. For another example, M can be predefined based on a frequency range wherein the SS/PBCH block is transmitted. For yet another example, M can be predefined based on a band number. For yet another example, M can be predefined based on a global synchronization channel number (GSCN) value associated with the SS/PBCH block transmission.

In one example, G can be configurable and provided by a higher layer parameter, e.g., after initial cell search procedure.

In another example, G can be predefined, e.g., in an initial cell search procedure. For one example, G can be predefined as 0. For another example, G can be predefined as the difference between a half frame and D.

In one embodiment, a QCL assumption can be supported for the SS/PBCH blocks transmitted using the second SS/PBCH block burst pattern.

For one example, a UE can assume SS/PBCH blocks with a same SS/PBCH block index (or a same candidate SS/PBCH block index) are QCLed, wherein the SS/PBCH blocks can be located according to at least one of the following cases: (i) in different SS/PBCH block bursts within a same periodicity, if the transmission is in a periodic manner; (ii) in different SS/PBCH block bursts within the transmission, if the transmission is in an aperiodic manner; and (iii) in different periodicities, if the transmission is in a periodic manner.

In another embodiment, sequences mapped for PSS in different time durations within the same periodicity, if the transmission is in a periodic manner, or in different time durations of the transmission, if the transmission is in an aperiodic manner, can be different.

For one example, a first sequence is mapped for PSS in a first time duration and a second sequence is mapped for PSS in a second time duration, wherein the first sequence and the second sequence are generated using the same cyclic shift and different generation functions and/or different initial conditions.

For another example, a first sequence is mapped for PSS in a first time duration and a second sequence is mapped for PSS in a second time duration, wherein the first sequence and the second sequence are generated using the same generation function and initial condition, and different cyclic shifts.

For yet another embodiment, sequences mapped for SSS in different time durations within the same periodicity, if the transmission is in a periodic manner, or in different time durations of the transmission, if the transmission is in an aperiodic manner, can be different.

For one example, a first sequence is mapped for SSS in a first time duration and a second sequence is mapped for SSS in a second time duration, wherein the first sequence and the second sequence are generated using the same cyclic shift and different generation functions and/or different initial conditions.

For another example, a first sequence is mapped for SSS in a first time duration and a second sequence is mapped for SSS in a second time duration, wherein the first sequence and the second sequence are generated using the same generation function and initial condition, and different cyclic shifts.

In one embodiment, a third SS/PBCH block burst pattern can be supported.

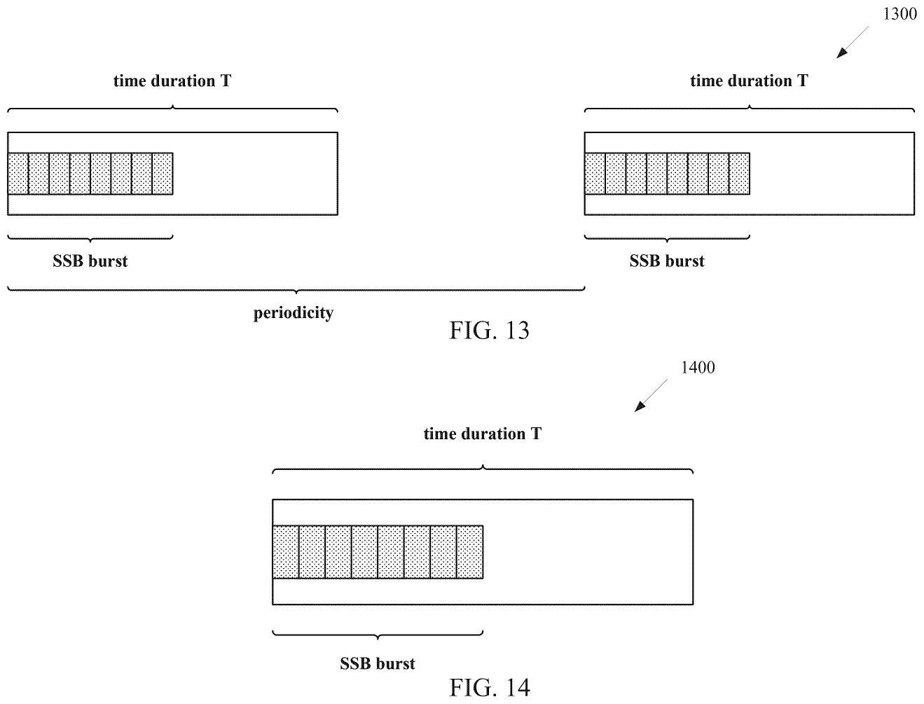

FIG. 13 illustrates yet another example of second SS/PBCH block burst pattern in a periodic manner 1300 according to embodiments of the present disclosure. An embodiment of second SS/PBCH block burst pattern in a periodic manner 1300 shown in FIG. 13 is for illustration only.

For one example, as illustrated in FIG. 13, SS/PBCH block(s) can be transmitted in a periodic manner, and within each periodicity, one SS/PBCH block burst can be transmitted and confined within a time duration.

FIG. 14 illustrates yet another example of second SS/PBCH block burst pattern in an aperiodic manner 1400 according to embodiments of the present disclosure. An embodiment of the second SS/PBCH block burst pattern in an aperiodic manner 1400 shown in FIG. 14 is for illustration only.

For another example, as illustrated in FIG. 14, SS/PBCH block(s) can be transmitted in an aperiodic manner, and one SS/PBCH block burst can be transmitted and confined within a time duration.

The following notations may be used for the present disclosure: (i) P: a periodicity of the SS/PBCH block transmission, e.g., applicable when the transmission of SS/PBCH block burst is periodic; (ii) T: a time duration including the SS/PBCH block burst in a periodicity; (iii) D: a transmission duration of a SS/PBCH block burst. For example, it refers to the duration of slots including the SS/PBCH block burst, and the duration includes gaps between/before/after SS/PBCH blocks in the burst; and (iv) M: a number (or a maximum number) of SS/PBCH blocks in a SS/PBCH block burst (e.g., SS/PBCH blocks in the SS/PBCH block burst are indexed from 0 to M-1).

In one example, P can be configurable and provided by a higher layer parameter, e.g., after initial cell search procedure.

In another example, P can be predefined when it is not configured, e.g., in an initial cell search procedure. For one example, P can be predefined based on a SCS of the SS/PBCH block. For another example, P can be predefined based on a frequency range wherein the SS/PBCH block is transmitted. For yet another example, P can be predefined based on a band number. For yet another example, P can be predefined based on a GSCN value associated with the SS/PBCH block transmission. For yet another example, P can be predefined as 40 ms. For yet another example, P can be predefined as 80 ms. For yet another example, P can be predefined as 160 ms.

In one example, the time duration T can be predefined, e.g., in an initial cell search procedure. For one example, T can be predefined as a half frame (e.g., 5 ms). For another example, T can be predefined as 20 ms. For yet another example, T can be predefined as a time unit to include all candidate occasions for SS/PBCH blocks in the SS/PBCH block burst within a periodicity.

In another example, the time duration T can be configured, e.g., provided by a higher layer parameter, such as a system information block and/or a dedicated RRC signalling, e.g., after initial cell search procedure.

In yet another example, the time duration T can be same as the transmission duration of the SS/PBCH block burst. In one example, the transmission duration of a SS/PBCH block burst (e.g., D) can be predetermined based on the number (or the maximum number) of SS/PBCH blocks in a SS/PBCH block burst (e.g., M). For example, D=M/2 when D is a unit of slot.

In one example, M can be configurable and provided by a higher layer parameter, or determined based on a higher layer parameter, e.g., after initial cell search procedure.

In another example, M can be predefined, e.g., in an initial cell search procedure. For one example, M can be predefined based on a SCS of the SS/PBCH block. For another example, M can be predefined based on a frequency range wherein the SS/PBCH block is transmitted. For yet another example, M can be predefined based on a band number. For yet another example, M can be predefined based on a GSCN value associated with the SS/PBCH block transmission. For yet another example, M can be predefined based on a number of (or a maximum number of) beams of SS/PBCH blocks or actually transmitted SS/PBCH blocks and an integer referring to the number of repetitions. For example, M=N·M′, where N is the number of repetitions, and M′ is the number of (or a maximum number of) beams of SS/PBCH blocks or actually transmitted SS/PBCH blocks.

In one embodiment, a QCL assumption can be supported for the SS/PBCH blocks transmitted using the third SS/PBCH block burst pattern. For one example, a UE can assume SS/PBCH blocks with a same SS/PBCH block index (or a same candidate SS/PBCH block index) are QCLed, wherein the SS/PBCH blocks can be located according to at least one of the following cases: (i) in different SS/PBCH block bursts within a same periodicity, if the transmission is in a periodic manner; (ii) in different SS/PBCH block bursts within the transmission, if the transmission is in an aperiodic manner; and (iii) in different periodicities, if the transmission is in a periodic manner.

For another example, a UE can determine a QCL assumption parameter Q, and the UE assumes SS/PBCH blocks with a same value given by (i mod Q) are QCLed, wherein i is the SS/PBCH block index (or candidate SS/PBCH block index) and the SS/PBCH blocks can be located according to at least one of the following cases: (i) within a same periodicity, if the transmission is in a periodic manner; (ii) within the transmission, if the transmission is in an aperiodic manner; (iii) in different periodicities, if the transmission is in a periodic manner.

For one example, Q can be provided by higher layer parameter(s), or determined based on higher layer parameters, e.g., after initial cell search procedure.

For another example, Q can be predefined, e.g., in an initial cell search procedure.

For yet another example, Q can be same as M′.

For yet another example, a UE can determine a QCL assumption parameter Q, and the UE assumes SS/PBCH blocks with a same value given by floor(i/Q) are QCLed, wherein i is the SS/PBCH block index (or candidate SS/PBCH block index) and the SS/PBCH blocks can be located according to at least one of the following cases: (i) within a same periodicity, if the transmission is in a periodic manner; (ii) within the transmission, if the transmission is in an aperiodic manner; and (iii) in different periodicities, if the transmission is in a periodic manner.

For one example, Q can be provided by higher layer parameter(s), or determined based on higher layer parameters, e.g., after initial cell search procedure. For another example, Q can be predefined, e.g., in an initial cell search procedure. For example, Q=2. For yet another example, Q can be same as N. For yet another example, Q=P/20.

For yet another example, a UE can determine a QCL assumption parameter Q, and the UE assumes SS/PBCH blocks with a same value given by floor(i/(M/Q)) are QCLed, wherein i is the SS/PBCH block index (or candidate SS/PBCH block index) and the SS/PBCH blocks can be located according to at least one of the following cases: (i) within a same periodicity, if the transmission is in a periodic manner; (ii) within the transmission, if the transmission is in an aperiodic manner; and (iii) in different periodicities, if the transmission is in a periodic manner.

For one example, Q can be provided by higher layer parameter(s), or determined based on higher layer parameters, e.g., after initial cell search procedure. For another example, Q can be predefined, e.g., in an initial cell search procedure. For yet another example, Q can be same as M′.

In one embodiment, sequences mapped for PSS in the QCLed SS/PBCH blocks can be different.

For one example, a first sequence is mapped for PSS in a first SS/PBCH block and a second sequence is mapped for PSS in a second SS/PBCH block, wherein the first and second SS/PBCH blocks are QCLed, and the first sequence and the second sequence are generated using the same cyclic shift and different generation functions and/or different initial conditions.

For another example, a first sequence is mapped for PSS in a first SS/PBCH block and a second sequence is mapped for PSS in a second SS/PBCH block, wherein the first and second SS/PBCH blocks are QCLed, and the first sequence and the second sequence are generated using the same generation function and initial condition, and different cyclic shifts.

In one embodiment, sequences mapped for SSS in the QCLed SS/PBCH blocks can be different.

For one example, a first sequence is mapped for SSS in a first SS/PBCH block and a second sequence is mapped for SSS in a second SS/PBCH block, wherein the first and second SS/PBCH blocks are QCLed, and the first sequence and the second sequence are generated using the same cyclic shift and different generation functions and/or different initial conditions.

For another example, a first sequence is mapped for SSS in a first SS/PBCH block and a second sequence is mapped for SSS in a second SS/PBCH block, wherein the first and second SS/PBCH blocks are QCLed, and the first sequence and the second sequence are generated using the same generation function and initial condition, and different cyclic shifts.

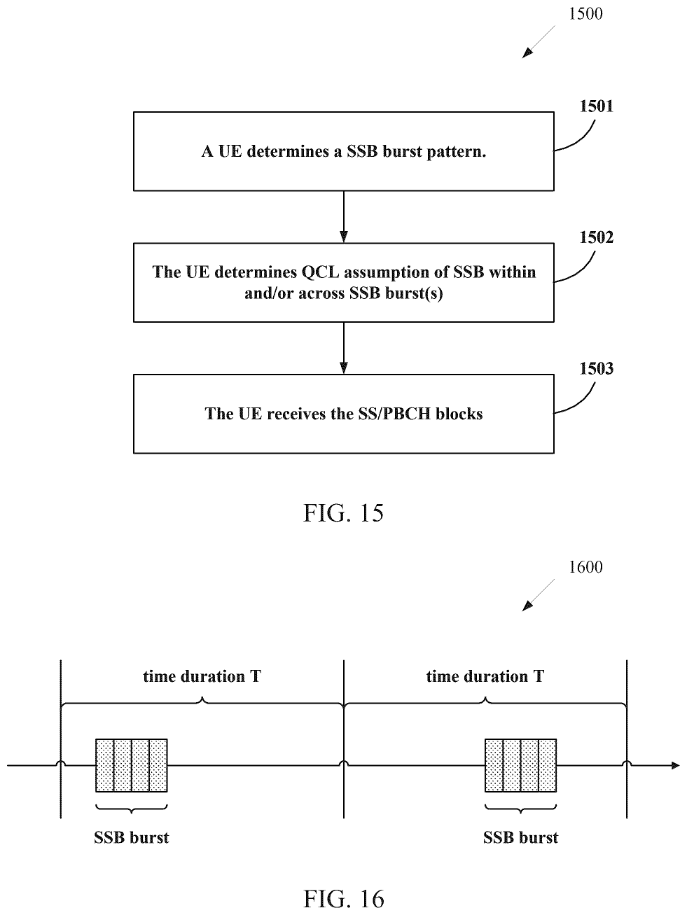

FIG. 15 illustrates a flowchart of UE method 1500 for determining and using the SS/PBCH block burst pattern according to embodiments of the present disclosure. The UE method 1500 may be performed by a UE (e.g., 111-116 as illustrated in FIG. 1). An embodiment of the UE method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

In one embodiment, an example UE procedure for determining and using the SS/PBCH block burst pattern is shown in FIG. 15.

As illustrated in FIG. 15, a UE in step 1501 determines a SSB burst pattern. Subsequently, the UE in step 1502 determines QCL assumption of SSB within and/or across SSB burst(s). Finally, the UE in step 1503 receives the SS/PBCH blocks.

The present disclosure provides the non-periodic synchronization signals. More precisely, the present disclosure provides: (i) non-periodic SSB transmission pattern: (a) Pattern 1: Each SSB burst in a time duration, (b) Pattern 2: Each SSB burst in a time window, (c) Pattern 3: Each SSB burst in multiple time windows, and (d) Pattern 4: Each SSB burst in a sliding window; (ii) an indication of non-periodic SSB transmission; (iii) an indication of timing by the non-periodic SSB; (iv) measurement based on non-periodic SSB; and (v) UE procedures.

In one embodiment, a transmission of synchronization signals block (SSB), e.g., which may further include physical broadcast channel (PBCH) multiplexed in the SSB, can be non-periodic.

A transmission pattern of the SSB can be according to at least one example of this disclosure.

In one example, a set of non-overlapping and consecutive time durations can be defined in the time domain, and each time duration has a same duration of T. A UE may assume the base station transmit a SSB or a SSB burst within each time duration within the set of time durations. The starting time instance of the transmission for the SSB or SSB burst can differ across the time durations, such that the transmission for the SSB or SSB burst may not be periodic. An illustration of the example is shown in FIG. 16.

FIG. 16 illustrates an example of non-periodic SSB transmission pattern 1600 according to embodiments of the present disclosure. An embodiment of the non-periodic SSB transmission pattern 1600 shown in FIG. 16 is for illustration only.

For one example, the time duration can be a number of frames, and the starting and ending time instances of the time duration are aligned with frame boundaries.

For another example, the time duration can be a number of half frames, and the starting and ending time examples of the time duration are aligned with half frame boundaries.

For yet another example, the time duration can be a number of subframes, and the starting and ending time instances of the time duration are aligned with subframe boundaries.

For yet another example, the time duration can be a number of slots, and the starting and ending time instances of the time duration are aligned with slot boundaries.

For one example, the value of T can be pre-determined, e.g., at least pre-determined as a default one for an initial cell search procedure, or at least pre-determined as a default one when no configuration or indication of such value is provided.

For another example, the value of T can be configured by the base station, e.g., by a higher layer parameter.

For yet another example, the value of T can be indicated by the base station, e.g., by control information.

For one example, a UE can assume at least one SSB or one SSB burst can be received in a duration of 2·T.

For one example, a UE can assume SSBs with same SSB index in different bursts or different time durations are QCLed.

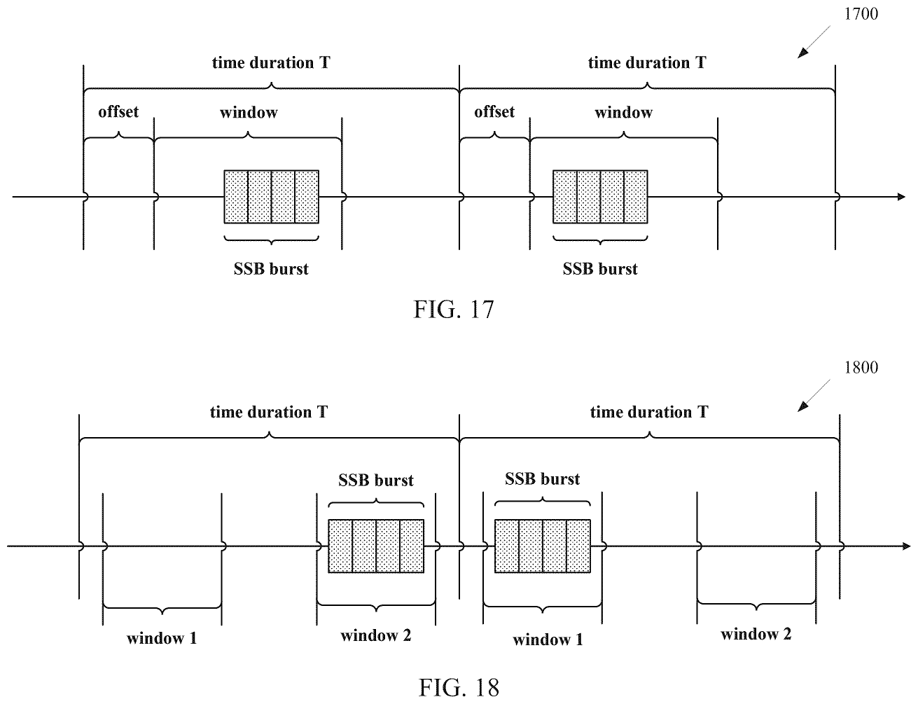

In one example, a set of non-overlapping and consecutive time durations can be defined in the time domain, and each time duration has a same duration of T. A time domain window is confined within a time duration. The set of time domain windows are periodic with a periodicity of T. Each time domain window has a duration of D, and has a time offset O comparing to the start of the corresponding time duration. A UE may assume the base station transmit a SSB or a SSB burst within a time domain window. The starting time instance of the transmission for the SSB or SSB burst can differ across the time domain windows, such that the transmission for the SSB or SSB burst may not be periodic. An illustration of the example is shown in FIG. 17.

FIG. 17 illustrates another example of non-periodic SSB transmission pattern 1700 according to embodiments of the present disclosure. An embodiment of the non-periodic SSB transmission pattern 1700 shown in FIG. 17 is for illustration only.

For one example, the time duration can be a number of frames, and the starting and ending time instances of the time duration are aligned with frame boundaries.

For another example, the time duration can be a number of half frames, and the starting and ending time instances of the time duration are aligned with half frame boundaries.

For yet another example, the time duration can be a number of subframes, and the starting and ending time instances of the time duration are aligned with subframe boundaries.

For yet another example, the time duration can be a number of slots, and the starting and ending time instances of the time duration are aligned with slot boundaries.

For one example, the value of T can be pre-determined, e.g., at least pre-determined as a default one for an initial cell search procedure, or at least pre-determined as a default one when no configuration or indication of such value is provided.

For another example, the value of T can be configured by the base station, e.g., by a higher layer parameter.

For yet another example, the value of T can be indicated by the base station, e.g., by control information.

For one example, the time domain window can be a number of frames, and the starting and ending time instances of the time domain window are aligned with frame boundaries.

For another example, the time domain window can be a number of half frames, and the starting and ending time instances of the time domain window are aligned with half frame boundaries.

For yet another example, the time domain window can be a number of subframes, and the starting and ending time instances of the time domain window are aligned with subframe boundaries.

For yet another example, the time domain window can be a number of slots, and the starting and ending time instances of the time domain window are aligned with slot boundaries.

For one example, the value of D can be pre-determined, e.g., at least pre-determined as a default one for an initial cell search procedure, or at least pre-determined as a default one when no configuration or indication of such value is provided.

For another example, the value of D can be configured by the base station, e.g., by a higher layer parameter.

For yet another example, the value of D can be indicated by the base station, e.g., by control information.

For one example, the time domain offset can be a number of frames.

For another example, the time domain offset can be a number of half frames.

For yet another example, the time domain offset can be a number of subframes.

For yet another example, the time domain offset can be a number of slots.

For yet another example, the time domain offset can be a number of OFDM symbols.

For one example, the value of O can be pre-determined, e.g., at least pre-determined as a default one for an initial cell search procedure, or at least pre-determined as a default one when no configuration or indication of such value is provided. For one example, O=0.

For another example, the value of O can be configured by the base station, e.g., by a higher layer parameter.

For yet another example, the value of O can be indicated by the base station, e.g., by control information.

For one example, a UE can assume at least one SSB or one SSB burst can be received in a duration of T+D.

For one example, a UE can assume SSBs with same SSB index in different bursts or different time durations or different windows are QCLed.

In one example, a set of non-overlapping and consecutive time durations can be defined in the time domain, and each time duration has a same duration of T. At least two time domain windows are confined within a time duration. Each time domain window is periodically occurring with a periodicity of T. The time domain window withi index i has a duration of Dᵢ, and has a time offset Oᵢ comparing to the start of the corresponding time duration. A UE may assume the base station transmit a SSB or a SSB burst within a time domain window within the at least two time domain windows in a time duration. The time domain window for the transmission for the SSB or SSB burst can differ across the time durations, and/or the starting time instance of the transmission for the SSB or SSB burst can differ across the time window and/or time durations, such that the transmission for the SSB or SSB burst may not be periodic. An illustration of the example is shown in FIG. 18.

FIG. 18 illustrates yet another example of non-periodic SSB transmission pattern 1800 according to embodiments of the present disclosure. An embodiment of the non-periodic SSB transmission pattern 1800 shown in FIG. 18 is for illustration only.

For one example, the time duration can be a number of frames, and the starting and ending time instances of the time duration are aligned with frame boundaries.

For another example, the time duration can be a number of half frames, and the starting and ending time instances of the time duration are aligned with half frame boundaries.

For yet another example, the time duration can be a number of subframes, and the starting and ending time instances of the time duration are aligned with subframe boundaries.

For yet another example, the time duration can be a number of slots, and the starting and ending time instances of the time duration are aligned with slot boundaries.

For one example, the value of T can be pre-determined, e.g., at least pre-determined as a default one for an initial cell search procedure, or at least pre-determined as a default one when no configuration or indication of such value is provided.

For another example, the value of T can be configured by the base station, e.g., by a higher layer parameter.

For yet another example, the value of T can be indicated by the base station, e.g., by control information.

For one example, the time domain window can be a number of frames, and the starting and ending time instances of the time domain window are aligned with frame boundaries.

For another example, the time domain window can be a number of half frames, and the starting and ending time instances of the time domain window are aligned with half frame boundaries.

For yet another example, the time domain window can be a number of subframes, and the starting and ending time instances of the time domain window are aligned with subframe boundaries.

For yet another example, the time domain window can be a number of slots, and the starting and ending time instances of the time domain window are aligned with slot boundaries.

For one example, the value of Dᵢ can be pre-determined, e.g., at least pre-determined as a default one for an initial cell search procedure, or at least pre-determined as a default one when no configuration or indication of such value is provided.

For another example, the value of Dᵢ can be configured by the base station, e.g., by a higher layer parameter.

For yet another example, the value of Dᵢ can be indicated by the base station, e.g., by control information.

For one example, the time domain offset can be a number of frames.

For another example, the time domain offset can be a number of half frames.

For yet another example, the time domain offset can be a number of subframes.

For yet another example, the time domain offset can be a number of slots.

For yet another example, the time domain offset can be a number of OFDM symbols.

For one example, the value of Oᵢ can be pre-determined, e.g., at least pre-determined as a default one for an initial cell search procedure, or at least pre-determined as a default one when no configuration or indication of such value is provided. For one example, Oᵢ=0.

For another example, the value of Oᵢ can be configured by the base station, e.g., by a higher layer parameter.

For yet another example, the value of Oᵢ can be indicated by the base station, e.g., by control information.

For one example, for at least one of the time domain window, a starting time instance of the time domain window can be aligned with the starting time of the time duration, e.g., Oᵢ=0.

For another example, for at least one of the time domain window, an ending time instance of the time domain window can be aligned with the ending time of the time duration, e.g., Oᵢ=T−Dᵢ.

For yet another example, for at least one of the time domain window, a starting time instance of the time domain window can be aligned with the starting time of the time duration, e.g., Oᵢ=0; and for at least another one of the time domain window, an ending time instance of the time domain window can be aligned with the ending time of the time duration, e.g., Oⱼ=T−Dⱼ. For this example, the two time domain window can be considered as one time domain window that spans across the boundary of the time duration, and is with a total duration of Dᵢ+Dⱼ.

For one example, a UE can assume SSBs with same SSB index in different bursts or different time durations or different windows are QCLed.

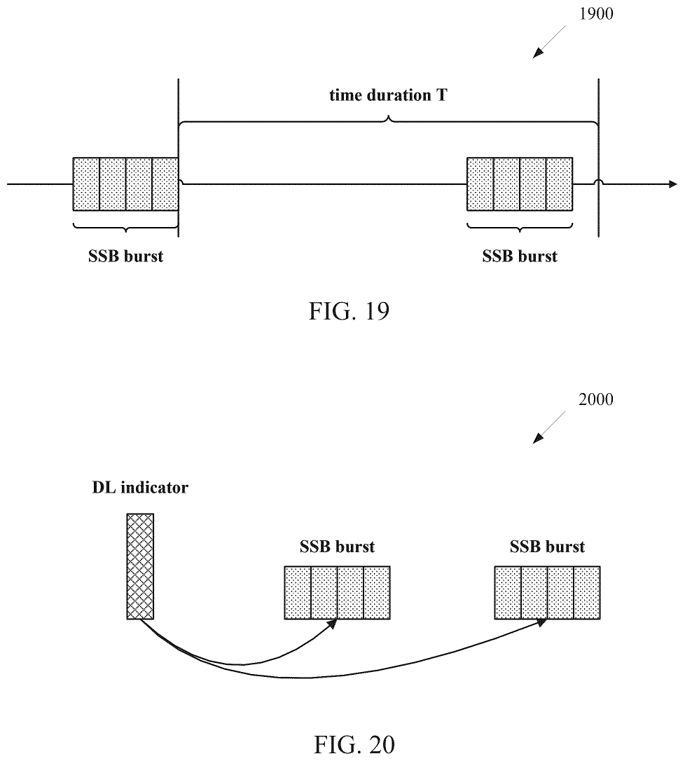

In one example, a UE may assume a SSB or a SSB burst can be received within a time duration of T. If a UE receives a SSB or a SSB burst, the UE can expect to receive another SSB or another SSB burst in the next time duration of T. An illustration of the example is shown in FIG. 19.

FIG. 19 illustrates yet another example of non-periodic SSB transmission pattern 1900 according to embodiments of the present disclosure. An embodiment of the non-periodic SSB transmission pattern 1900 shown in FIG. 19 is for illustration only.

For one example, the time duration can be a number of frames.

For another example, the time duration can be a number of half frames.

For yet another example, the time duration can be a number of subframes.

For yet another example, the time duration can be a number of slots.

For one example, the value of T can be pre-determined, e.g., at least pre-determined as a default one for an initial cell search procedure, or at least pre-determined as a default one when no configuration or indication of such value is provided.

For another example, the value of T can be configured by the base station, e.g., by a higher layer parameter.

For yet another example, the value of T can be indicated by the base station, e.g., by control information.

For one example, a UE can assume SSBs with same SSB index in different bursts are QCLed.

FIG. 20 illustrates an example of indication of non-periodic SSB transmission 2000 according to embodiments of the present disclosure. An embodiment of the indication of non-periodic SSB transmission 2000 shown in FIG. 20 is for illustration only.

In one embodiment, a transmission of SSB or SSB burst can be indicated by a downlink (DL) signal and/or channel, e.g., denoted as a DL indicator.

For one example, the DL indicator can be a physical downlink control channel (PDCCH) carrying a downlink control information (DCI) format.

For another example, the DL indicator can be a physical downlink shared channel (PDSCH) carrying a MAC CE.

For yet another example, the DL indicator can be a physical downlink shared channel (PDSCH) carrying an RRC parameter.

For one example, the DL indicator can indicate a time domain occasion(s) for the transmission of the SSB or the SSB burst.

For one example, the DL indicator can indicate an absolute timing of the time domain occasion(s) for the transmission of the SSB or the SSB burst, e.g., a system frame number (SFN), a half frame index, a subframe index, or a slot index.

For another example, the DL indicator can indicate a relative timing of the time domain occasion(s) for the transmission of the SSB or the SSB burst, e.g., comparing to the slot or OFDM symbol(s) that includes the DL indicator, or comparing to the slot or OFDM symbol(s) that includes the feedback (e.g., HARQ-ACK feedback) of the DL indicator.

For yet another example, the DL indicator can indicate a number of SSB bursts that the UE may receive.

For yet another example, the DL indicator can indicate a number of SSBs in a SSB burst that the UE may receive.

For yet another example, the DL indicator can indicate a pattern of SSBs in a SSB burst that the UE may receive.

In one embodiment, timing information can be carried by a non-periodic SSB.

For one example, the timing information can include a SFN or X most significant bit (MSB) of the SFN or X least significant bit (LSB) of the SFN, wherein X is an integer between 1 to 10.

For another example, the timing information can include a half frame number.

For yet another example, the timing information can include a slot index.

For yet another example, the timing information can include an OFDM symbol index.

For yet another example, the timing information can include a SSB index (e.g., indicating an index of SSB in the time domain within a burst), or Y MSB of the SSB index, or Y LSB of the SSB index.

For one example, the timing information can be carried by a PSS in the non-periodic SSB.

For another example, the timing information can be carried by a SSS in the non-periodic SSB.

For yet another example, the timing information can be carried by a DM-RS of PBCH in

the non-periodic SSB.

For yet another example, the timing information can be carried by a payload of PBCH (e.g., including MIB) in the non-periodic SSB.

For yet another example, the timing information can be carried by a combination of at least one example disclosed in the present disclosure.

In one embodiment, a UE can be configured to perform measurement based on non-periodic SSB.

For one example, the measurement can be RRM measurement.

For another example, the measurement can be RLM measurement.

For yet another example, the measurement can be L1-measurement.

For yet another example, the measurement can be L3-measurement.

For one example, the UE can be configured with at least one measurement window to perform measurement.

For one example, the measurement window can periodically occur in the time domain.

For another example, the configuration for the measurement window can include a periodicity.

For yet another example, the configuration for the measurement window can include a time offset with respect to a timing instance.

For yet another example, the configuration for the measurement window can include a duration of the window.

For yet another example, the measurement window can be same as the time window for transmitting or receiving the SSB.

For yet another example, the measurement window can include the time window for transmitting or receiving the SSB.

For yet another example, the measurement window can be within the time window for transmitting or receiving the SSB.

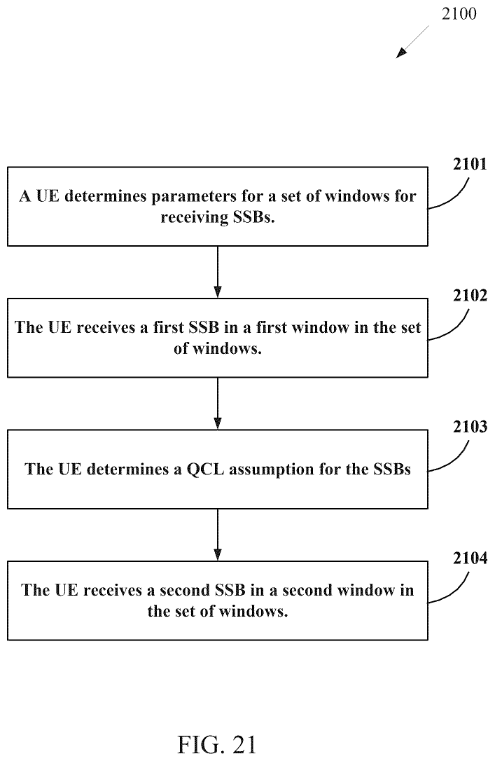

FIG. 21 illustrates a flowchart of UE method 2100 for an indication of non-periodic SSB transmission according to embodiments of the present disclosure. The UE method 2100 may be performed by a UE (e.g., 111-116 as illustrated in FIG. 1). An embodiment of the UE method 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

As illustrated in FIG. 21, a UE in step 2101 determines parameters for a set of windows for receiving SSBs. Subsequently, in step 2102, the UE receives a first SSB in a first window in the set of windows. Subsequently, in step 2103, the UE determines a QCL assumption for the SSBs. Finally, in step 2104, the UE receives a second SSB in a second window in the set of windows.

In one embodiment, candidate SSB locations can be pre-defined or configured within the time duration or the time window, and the SSB burst may select all or a subset from the candidate SSB locations to perform the transmission.

For one example, the candidate SSB locations can be indexed from 0 to N-1, using a candidate SSB index ī_{SSB}, wherein N is the number of candidate SSB locations within the time duration or the time window.

For another example, N can be provided by a higher layer parameter. For one example, the higher layer parameter can be system information. For another example, the higher layer parameter can be a dedicated RRC parameter. For yet another example, the higher layer parameter can be MIB. For yet another example, when the higher layer parameter is not provided, the UE can pre-determine a value of N, e.g., as the maximum number of candidate SSB locations within the time duration or the time window.

For yet another example, a UE can assume SSBs are QCLed, if the candidate SSB indexes of the SSBs have the same value of (ī_{SSB}mod Q). For one example, Q can be provided by a higher layer parameter, such as system information, and/or a dedicated RRC parameter, and/or MIB. For another example, if the higher layer parameter is not provided, the UE can pre-determine a value of Q, e.g., as the maximum number of SSB beams or maximum value of SSB index+1.

For yet another example, the UE can determine a SSB index based on the candidate SSB index as i_{SSB}=(ī_{SSB} mod Q), wherein ī_{SSB} is the candidate SSB index.

For yet another example, a UE can assume SSBs are QCLed, if the candidate SSB indexes of the SSBs have the same value of floor(ī_{SSB}/Q). For one example, Q can be provided by a higher layer parameter, such as system information, and/or a dedicated RRC parameter, and/or MIB. For another example, if the higher layer parameter is not provided, the UE can pre-determine a value of Q, e.g., as the maximum number of SSB beams or maximum value of SSB index+1.

For yet another example, the UE can determine a SSB index based on the candidate SSB index as i_{SSB}=floor(ī_{SSB}/Q), wherein ī_{SSB} is the candidate SSB index.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
identify a time domain pattern for synchronization signals and physical broadcast channel (SS/PBCH) block bursts, wherein the time domain pattern indicates:
a periodicity for the SS/PBCH block bursts;
a first number (N) of SS/PBCH block bursts in the periodicity; and
a second number (M) of SS/PBCH blocks in a SS/PBCH block burst within the SS/PBCH block bursts; and
determine time domain candidate occasions for the SS/PBCH blocks based on the time domain pattern; and
a transceiver operably coupled to the processor, the transceiver configured to receive a SS/PBCH block from the SS/PBCH blocks in the time domain candidate occasions.

2. The UE of claim 1, wherein the periodicity is:
a predefined value, when the UE is performing an initial cell search procedure; or
configured by a higher layer parameter, otherwise.

3. The UE of claim 1, wherein the first number is:
determined based on a global synchronization channel number (GSCN) value associated with the SS/PBCH blocks, when the UE is performing an initial cell search procedure; or
configured by a higher layer parameter, otherwise.

4. The UE of claim 1, wherein the second number is:
a predefined value, when the UE is performing an initial cell search procedure; or
configured by a higher layer parameter, otherwise.

5. The UE of claim 1, wherein the processor is further configured to determine that an (m+1)-th SS/PBCH block in the SS/PBCH block burst is with a SS/PBCH block index m, where m is an integer satisfying 0≤m≤M-1.

6. The UE of claim 5, wherein a first SS/PBCH block in a first SS/PBCH block burst and a second SS/PBCH block in a second SS/PBCH block burst are quasi-co-located (QCLed), when the first SS/PBCH block and the second SS/PBCH block are with a same SS/PBCH block index.

7. The UE of claim 1, wherein:
the processor is further configured to determine a time domain gap between two consecutive SS/PBCH block bursts within the periodicity, and
the time domain gap is:
a predefined value, when the UE is performing an initial cell search procedure; or
configured by a higher layer parameter, otherwise.

8. A base station (BS) in a wireless communication system, the BS comprising:
a processor configured to:
determine a time domain pattern for synchronization signals and physical broadcast channel (SS/PBCH) block bursts, wherein the time domain pattern indicates:
a periodicity for the SS/PBCH block bursts;
a first number (N) of SS/PBCH block bursts in the periodicity; and
a second number (M) of SS/PBCH blocks in a SS/PBCH block burst within the SS/PBCH block bursts; and
determine time domain candidate occasions for the SS/PBCH blocks based on the time domain pattern; and
a transceiver operably coupled to the processor, the transceiver configured to transmit the SS/PBCH blocks in the time domain candidate occasions.

9. The BS of claim 8, wherein the periodicity is configured by a higher layer parameter.

10. The BS of claim 8, wherein the first number is configured by a higher layer parameter.

11. The BS of claim 8, wherein the second number is configured by a higher layer parameter.

12. The BS of claim 8, wherein the processor is further configured to determine that an (m+1)-th SS/PBCH block in the SS/PBCH block burst is with a SS/PBCH block index m, where m is an integer satisfying 0≤m≤M-1.

13. The BS of claim 12, wherein a first SS/PBCH block in a first SS/PBCH block burst and a second SS/PBCH block in a second SS/PBCH block burst are quasi-co-located (QCLed), when the first SS/PBCH block and the second SS/PBCH block are with a same SS/PBCH block index.

14. The BS of claim 8, wherein:
the processor is further configured to determine a time domain gap between two consecutive SS/PBCH block bursts within the periodicity, and
the time domain gap is configured by a higher layer parameter.

15. A method of a user equipment (UE) in a wireless communication system, the method comprising:
identifying a time domain pattern for synchronization signals and physical broadcast channel (SS/PBCH) block bursts, wherein the time domain pattern indicates:
a periodicity for the SS/PBCH block bursts;
a first number (N) of SS/PBCH block bursts in the periodicity; and
a second number (M) of SS/PBCH blocks in a SS/PBCH block burst within the SS/PBCH block bursts;
determining time domain candidate occasions for the SS/PBCH blocks, based on the time domain pattern; and
receiving a SS/PBCH block from the SS/PBCH blocks in the time domain candidate occasions.

16. The method of claim 15, wherein the periodicity is:
a predefined value, when the UE is performing an initial cell search procedure; or
configured by a higher layer parameter, otherwise.

17. The method of claim 15, wherein the first number is:
determined based on a global synchronization channel number (GSCN) value associated with the SS/PBCH blocks, when the UE is performing an initial cell search procedure; or
configured by a higher layer parameter, otherwise.

18. The method of claim 15, wherein the second number is:
a predefined value, when the UE is performing an initial cell search procedure; or
configured by a higher layer parameter, otherwise.

19. The method of claim 15, further comprising:
determining that an (m+1)-th SS/PBCH block in the SS/PBCH block burst is with a SS/PBCH block index m, where m is an integer satisfying 0≤m≤M-1,
wherein a first SS/PBCH block in a first SS/PBCH block burst and a second SS/PBCH block in a second SS/PBCH block burst are quasi-co-located (QCLed), when the first SS/PBCH block and the second SS/PBCH block are with a same SS/PBCH block index.

20. The method of claim 15, further comprising:
determining a time domain gap between two consecutive SS/PBCH block bursts within the periodicity,
wherein the time domain gap is:
a predefined value, when the UE is performing an initial cell search procedure; or
configured by a higher layer parameter, otherwise.
